(19) United States
(12) Patent Application Publication
(10) Pub. No.: US 2016/0065334 A1
(43) Pub. Date: Mar. 3, 2016

(54) Structure and Implementation Method for implementing an embedded serial data test loopback, residing directly under the device within a printed circuit board

(71) Applicant: R&D Circuits, Inc., South Plainfield, NJ (US)

(72) Inventors: Thomas P. Warwick, Melbourne, FL (US); James V. Russell, New Hope, PA (US)

(73) Assignee: R&D Circuits, Inc

(21) Appl. No.: 14/833,928

(22) Filed: Aug. 24, 2015

Related U.S. Application Data
(60) Provisional application No. 62/043,570, filed on Aug. 29, 2014.

(51) Int. Cl. H04L 1/24; H04L 12/26

(52) U.S. Cl. CPC H04L 1/243; H04L 43/0811; H04L 43/50

(57) ABSTRACT

A method and a structure with multiple implementations is provided that depends on the specific need, for placing (embedding) a serial loopback circuit of known design in a printed circuit board directly beneath the device under test. Micro-vias and traces connect components including transmitter components (TX) and receiver components (RX) that are formed into a loopback circuit for connection to a device under test (DUT). The connection is accomplished by a coupling capacitor with a shortest possible electrical length approximating a straight line between said components and said DUT and said distance is a length of said short straight line times a square root of 2 so that said receiver components are beneath the DUT.

### RELATED APPLICATIONS

The present application is a non-provisional application of provisional application Ser. No. 62/043,570 filed on Aug. 29, 2014 by Thomas P. Warwick and James V. Russell.

### BACKGROUND

1. Field

The present invention relates a structure and method for the automating testing of very high speed serial data transmission devices (integrated circuit) using the common industry practice of loopback circuitry. In particular the present invention relates to a series of structures and methods for placing commercially available components directly beneath the surface of a printed circuit board interfacing to a device under test by using micro-vias and traces to connect these components into a loopback circuit with the shortest possible electrical length by using a coupling capacitor.

2. The Related Prior Art

Loopback circuits are available in a variety of forms. The three most common loopback circuits use a relay-capacitor circuit, a resistor tap—capacitor circuit, an inductor tap—capacitor circuit (Thomas P. Warwick, R&D Circuits Vendor Presentation, International Test Conference, Anaheim, Calif., September, 2012; Thomas P. Warwick, “Mitigating the Effects of The DUT Interface board and Test System Parasitics in Gigabit-Plus Measurements”, International Test Conference, Charlotte, N.C., 2003). FIGS. 1-5 show the schematic implementation of the prior art common passive circuits used for serial loopback testing. Each circuit type provides a series of benefits and drawbacks regarding the types of tests that may be executed in an automated test environment. Each circuit requires a series of vias and printed circuit board real estate to implement. Of these, the relay circuits are physically the largest, and resistor tap—capacitor circuits the smallest.

FIG. 13 is a prior art illustration of a one-half cross section of the physical implementation of the schematics in FIGS. 1-5 in prior art. The transmit electrical signal (Tx) starts from the Device Under Test (DUT) [37] and routes from the DUT Tx to the loopback circuit through the via/backdrill structure [43], a connecting printed circuit board trace, and the via/backdrill structure [41]. [42] is the specific loopback structure, as shown schematically as either FIG. 1 or FIG. 5. The center component on the bottom of the Device Interface Board (DIB) [39] is the critical coupling capacitor [5] or [6], with the components to the left and right being the tap components: Resistors [7]/[8] or [9]/10] in FIG. 1; Inductors [17]/[18] or [19]/[20] in FIG. 5.

The three most common loop back circuits use a relay-capacitor circuit, a resistor tap—capacitor circuit, an inductor tap—capacitor circuit (Inventor Presentation, International Test Conference, Anaheim, Calif., September, 2012). Each circuit type provides a series of benefits and drawbacks regarding the types of tests that may be executed in an automated test environment. Each circuit requires a series of vias and printed circuit board real estate to implement. Of these, the relay circuits are physically the largest, and resistor tap—capacitor circuits the smallest.

The following problems occur with the prior art proposals for loopback circuits testing data rate above 19 GBPS.
(1) Size and required number of loopback circuits: Most devices operating above 19 GBS require 4 to 400 very high speed full loopback circuits with several lower speed loopback circuits, which require the same amount of printed circuit board real estate.
(2) Difficulty with long transmission paths to the loopback circuits: The most common test strategies for loopback require that the loopback circuitry be as close as possible to the transmitters and receivers. Even with the smallest possible loopback circuit, this length becomes large when a large number of loopback circuits are required. Long lengths may result in the required use of FIR taps to compensate for the line length. This limits the type of testing and determination of margins that can be done at speed.

The critical concern with any loopback structure (passive, such as FIGS. 1-5 or active, which use relays) is its jitter contribution. Physical structures and components, especially as data rates increase, result in impedance discontinuities, which, in turn, can cause undesired measurement jitter, when combined with other non-ideal structures (e.g. socket) associated with the test setup. Two gating factors determine undesired jitter: (1) the number of discontinuities and (2) the distance/electrical length between the discontinuities. Simply the spacing allows the reflected energy from a discontinuity to bounce back and forth—thus causing jitter—without being fully dissipated. Any time the time delay associated with the electrical length between discontinuities exceeds ⅜-½ of the primary period, unwanted jitter may occur. At 28 GBs, this distance is 4.4 to 5.9 mm (Dk=3.27). All the prior art methods described exceed ⅜-½ of the period resulting in jitter and electrical discontinuities.
(3) Spacing constraints on ATE-oriented printed circuit boards: Most production oriented solutions require multi-site testing of 2× to 4× devices at the same time. The physical size of the loopback circuits and the length matching required of the routes reduce available printed circuit board real estate in critical regions.
(4) Use of a large number of mismatched structures, such as back-drilled vias: Any via structure causes a level of impedance mismatch that cannot be compensated by under-sampling FIR filter taps, especially in test. FIR filters provide a common method of compensating for transmission path loss.) A typical loopback circuit adds a minimum of two additional vias in the primary loopback path. Controlled depth back-drilled vias or a like structure are absolutely required to remove excess metal stubs, which create very large electrical energy reflections and thus jitter. Manufacturing repeatability and the need for good interconnect reliability limit the electrical quality of these back-drilled vias, and they are of paramount concern for serial links operating above 14 Gbps. Each loopback path requires 8 such back-drilled vias.
(5) Required use of expensive, exotic materials to reduce trace losses: Expensive high-speed materials must be used to compensate for issue 2. It would be desirable to provide loop back circuit structures and methods that avoid these problems of the aforementioned prior art proposals.

### SUMMARY OF INVENTION

The present invention provides for a structure and methodology that reduces jitter and electrical discontinuities. The present invention has a number of embodiments and possible methods:

Embodiments:
1. Embedded loopback circuitry integrated into a device interface (printed circuit) board (DIB).
2. Embedded loopback circuitry integrated into an interposer, which is physically detachable from the fore-mentioned DIB. This allows retrofitting the loop back circuitry of the present invention to existing DIB's.

Methods:
1. Single layer embedding for large pitch (0.65 mm or larger)
2. Multiple layer embedding for fine pitch (0.5 mm and 0.4 mm).
3. Multi-axis (vertical and horizontal) embedding for the finest pitch (0.4 mm, 0.35 mm and 0.3 mm) and for higher performance.

This present invention provides a series of structures and methods for placing commercially available components directly beneath the surface of a printed circuit board interfacing to a device under test. The present invention specifically moves common passive test circuitry (See FIGS. 1-5 for schematics) from the outer surface of a device interface board (DIB) [42] in FIG. 13) to a location embedded inside the device interface board (DIB) just beneath the Device Under Test or DUT (See FIG. 14). An alternative implementation embeds the common circuitry in an interposer or daughter card just beneath the Device Under Test (See FIG. 15), which gives the benefit of retrofitting the approach to existing Device Interface Board hardware. The present invention uses micro-vias and traces to connect these components into a loopback circuit with the shortest possible electrical length using a coupling capacitor in the printed circuit board structure while using an external coupling capacitor. FIGS. 11 and 12 show the performance improvement @ 40 Gbps between Prior Art and the present invention, both use the schematic in FIG. 1.

FIGS. 6-9 show one-half cross-sectional views for different implementations of the embedded loopback circuit. They specifically use the higher component schematics, as shown in FIG. 1 and FIG. 5. FIGS. 6 and 7 pictorially describe implementation. In a first method of the present invention, all loopback components reside in the same plane (large pitch implementation). FIG. 8 pictorially describes implementation of a second method, where all loopback components reside in multiple planes (fine pitch implementation). FIG. 9 pictorially describes implementation of a third method where all loopback components reside in both vertical and horizontal orientations (finest pitch and highest performing implementation).

FIG. 16 is a top-down layout view and is critical to understanding the short distance benefit of the present invention. While FIG. 13 shows that the loopback circuitry of the prior art proposals must be mounted away from the device under test creating a long transmission path, FIG. 16 shows that the transmission path of the present invention can be within 1.41 multiplied by the straight line distance between Tx and Rx device pin locations thus reducing jitter and electrical discontinuities.

### BRIEF DESCRIPTION OF DRAWINGS

FIGS. 1-5 show prior art loop back circuitry proposals in which:

FIG. 1 is a diagram for a resistive tap embedded loopback circuit for test of the serial data link of a commonly implemented loopback schematic in the electronics industry today;

FIG. 2 shows a resistive tap embedded loopback circuit with an impedance matching and attenuating resistor [11] and [12]. (Ref. Warwick, ITC 2012) in which the dashed boxed areas represents the Tx [1], [2] and Rx [3], [4] terminals of the Device Under Test.;

FIG. 3 is for a capacitively coupled embedded loopback circuit, it is a simplified version of FIG. 1 in which the dashed boxed areas represents the Tx [1], [2] and Rx [3], [4] terminals of the Device Under Test and does not allow DC or low frequency testing of the serial port;

FIG. 4 is for a capacitively coupled embedded loopback circuit with an attenuating resistor, the dashed boxed areas represents the Tx [1], [2] and Rx [3], [4] terminals of the Device Under Test, it is a simplified version of FIG. 2;

FIG. 5 is for an inductive tap embedded loopback circuit For passive circuits below 10 Gbps, in which the dashed boxed areas represents the Tx [1], [2] and Rx [3], [4] terminals of the Device Under Test;

FIG. 6 is a first embodiment of the present invention for an embedded loopback circuit in a sectional view (1/2) wherein all components are co-planar and tap resistors [7-10] and tap inductors [17-20] may be interchanged and the tap inductors require air core cavity;

FIG. 7 is a variation of the embodiment of FIG. 6 in which the components are coplanar ion for an embedded loopback circuit in a sectional view (1/2);

FIG. 8 is a third embodiment providing for finer pitch wherein the embedded components (use two layers to allow for fine pitch implementation in a cross-sectional view (1/2),tap resistors [7-10] and tap inductors [17-20] may be interchanged (e.g. FIG. 5) and tap inductors require air core cavity;

FIG. 9 is a fourth embodiment of the present invention for an embedded loopback circuit employing multiple layers e.g. layers to allow for fine pitch implementation, tap components are oriented vertically, tap resistors [7-10] and tap inductors [17-20] may be interchanged and tap inductors require air core cavity;

FIG. 10 is a fifth embodiment of the present invention for an embedded loopback circuit providing for even finer pitch than the embodiment of FIG. 9 in a thicker printed circuit board;

FIG. 11 shows the data eye opening @ 40 Gbps using the best possible implementation of prior art;

FIG. 12 shows the data eye opening @ 40 Gbps using the Method 1 implementation of this present invention;

FIG. 13 a “prior art” method for implementing the schematics in FIGS. 1-5 for serial data loopback testing;

FIG. 14 shows an integrated embedded loopback circuitry for implementing the schematics in FIGS. 1-5;

FIG. 15 shows a detachable embedded loopback circuitry for implementing the schematics in FIGS. 1-5; and

FIG. 16 shows a top view of the embedded component loopback circuit using the schematic in FIG. 1 and the first method for large pitches in FIGS. 6 and 7

### DETAILED DESCRIPTION OF THE PREFERRED

### Embodiments

Referring to the FIGS. of the drawings, all the FIGS. use the following element numbers:
Transmit P Connection to the Device Under Test element 1
Transmit N Connection to the Device Under Test element 2
Receive P Connection to the Device Under Test element 3
Receive N Connection to the Device Under Test element 4
Coupling Capacitor for Differential P side of the Loopback (primary path) element 5
Coupling Capacitor for Differential N side of the Loopback (primary path) element 6
Measure/Tap Resistor for Transmit P element 7
Measure/Tap Resistor for Receive P element 8
Measure/Tap Resistor for Transmit N element 9
Measure/Tap Resistor for Receive N element 10
Attenuating Resistor for the Primary path, P side of the loopback element 11
Attenuating Resistor for the Primary path, N side of the loopback element 12
Test equipment connection for measurements on Transmit P element 13
Test equipment connection for measurements on Transmit N element 14
Test equipment connection for measurements on Receive P element 15
Test equipment connection for measurements on Receive N element 16
Measure/Tap Inductor for Transmit P element 17
Measure/Tap Inductor for Receive P element 18
Measure/Tap Inductor for Transmit N element 19
Measure/Tap Inductor for Receive N element 20
Connecting Trace: Capacitor 5/6 may be at the transmit end, in the middle of trace 21, or at the receive end (as shown) element 21
Upper ground plane for impedance control of trace 21 element 22
Lower ground plane for impedance control of trace 21 element 23
Connecting micro-trace for Receive tap resistor or inductor element 24
Connecting micro-trace for Transmit tap resistor or inductor element 25
Connecting via from loopback circuit to the device under test pad for Transmit element 26
Connecting via from loopback circuit to the device under test pad for Receive element 27
Micro-via connecting the receive tap component to trace 24 element 28
Micro-via connecting the receive tap component to trace 25 element 29
Micro-via or via connecting trace 24 to outside connections—whether external or internal (15/16) element 30
Micro-via or via connecting trace 25 to outside connections—whether external or internal (13/14) element 31

Non-conductive dielectric material containing the layer of embedded components. This layer helps to controls the impedance of trace 21 element 32.

Thin non-conductive dielectric layer for isolating trace 24 from the tap component. This layer helps to control the impedance of trace 21 element 33.

Thin non-conductive dielectric layer for isolating trace 24 from external connections to the structure element 34.

Thin non-conductive dielectric layer for isolating the component layer from external connections to the structure element 35.

Second non-conductive dielectric layer for housing the embedded tap resistors element 36. Example Device Under Test (DUT) with a serial data link. Element 37. For Explanation purposes, the device under test is shown in a “Ball Grid Array” (BGA) package. The device under test, shown as an integrated circuit package, may also be in wafer/die form. The exact form is peripheral to the disclosure and the methods described apply to any test forum including, but not limited to, wafer probing, final package test, burn-in, and characterization. Example electrical interface and mechanical clamping mechanism (socket or probe head) retaining the DUT to the interface board between the DUT and the test equipment using for measuring DUT characteristics and functionality element 38. In the simplest form this is a solder interface. The socket or probe head is shown for explanation purposes and is peripheral to the disclosure.

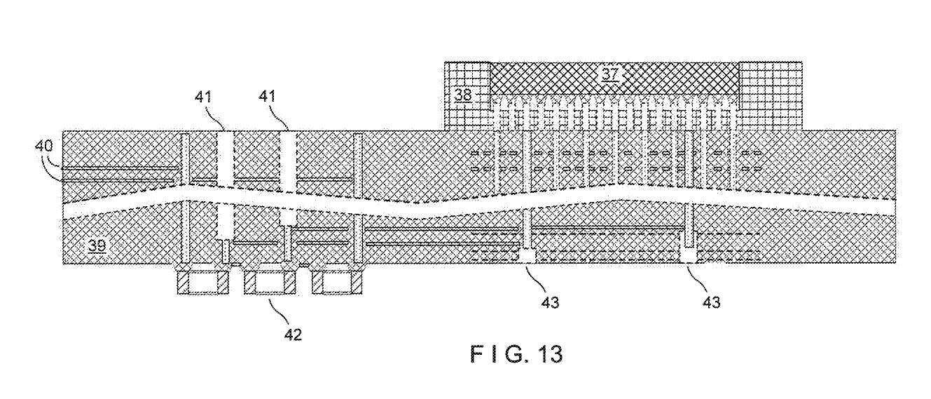

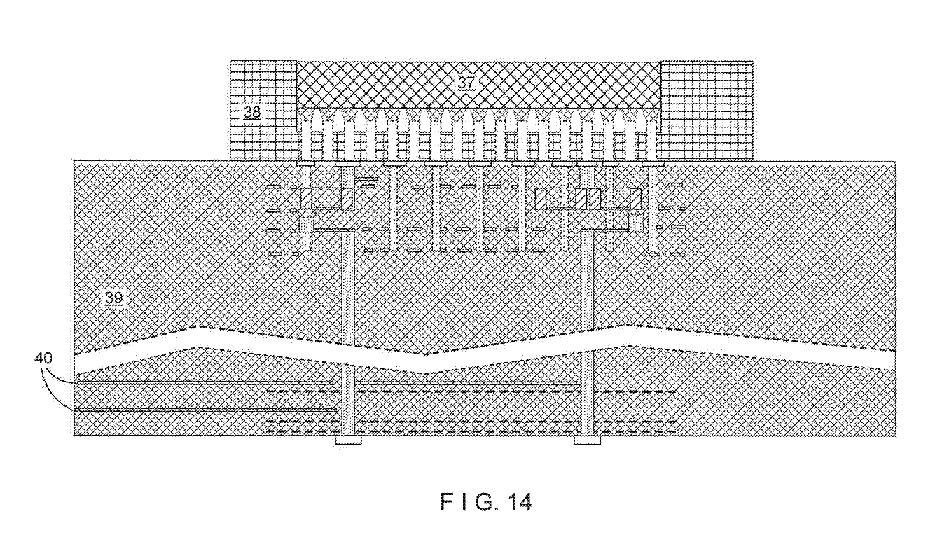

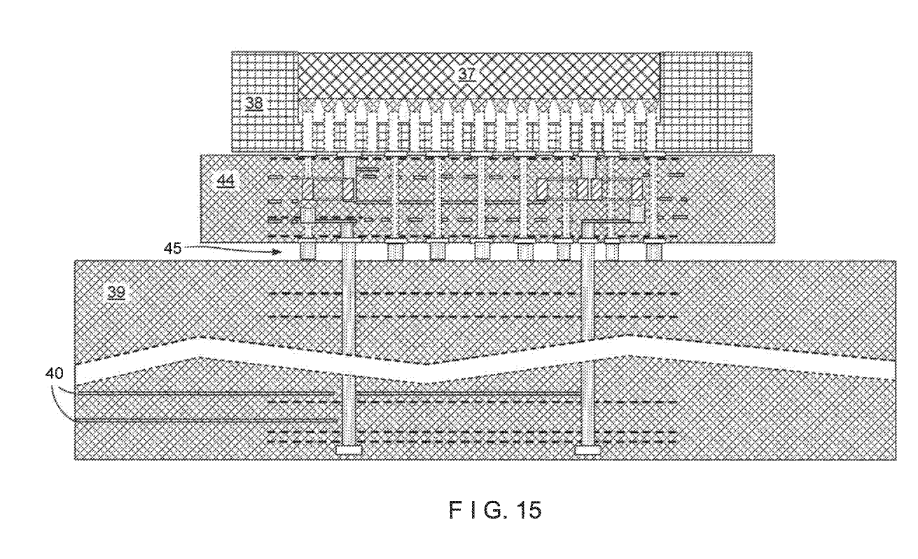

Example “Device Interface Board” (DIB), which electrically connects the DUT to test equipment element 39. Other common names include, but are not limited to, “Loadboard”, “Performance Board”, “Personality Board”, “Probe Card”, “Family Board”, “Mother Board”, “Daughter Card”. In nearly all cases the DIB is constructed using printed circuit board fabrication and assembly methods. In FIG. 13, item 39 represents a “Prior Art” DIB. In FIG. 14, item 39 shows the embedded loopback circuitry contained within the DIB. In FIG. 15, item 39 does not include the embedded loopback circuitry, as it is separately contained in an interposer/daughter card.

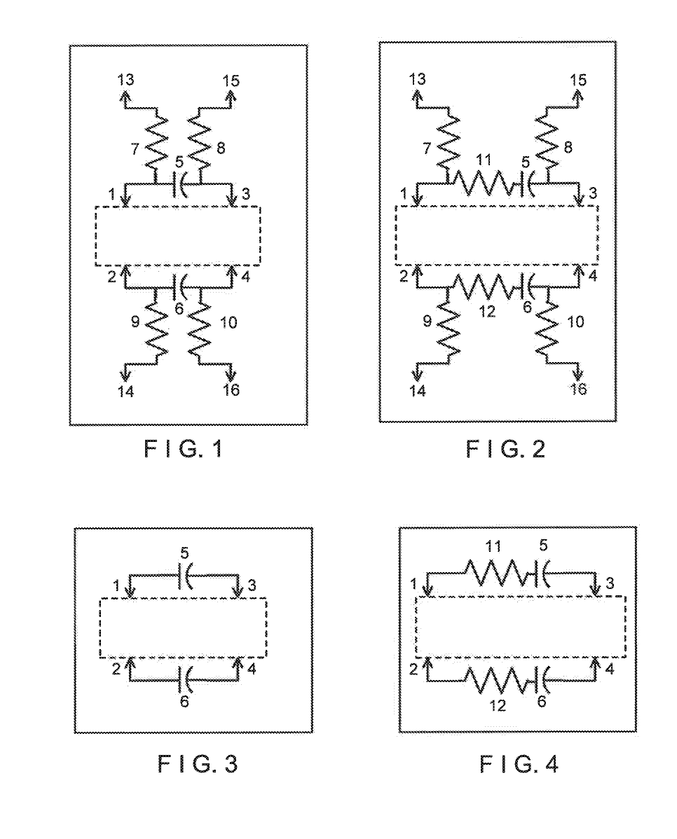

Electrical connections routing in the DIB that connect the DC/low frequency portion of the test circuit to the associated test equipment. In FIGS. 1, 2, and 5-10, these represent noted items [13], [14], [15], and [16] element 40.

High performance interface vias for the high frequency path and interface to the coupling capacitors [5] and [6] in FIGS. 1-5 element 41. These vias require a controlled depth back-drill to remove conductive metal stubs that will interfere with the circuit performance. The quality of this back-drill directly influences jitter performance. This item is specific to prior art and is shown for comparison purposes.

Location of the loopback circuit (FIGS. 1-5) for prior art element 42. Complex mechanical interfaces required for automated wafer probe test and automated package test physically force the loopback circuit location to be some distance away from the device under test. Typical distances range from 3″ to 5″, with 2″ for a device of moderate complexity being the best possible location. This item is specific to prior art and is shown for comparison purposes.

High performance interface vias for the high frequency path that allow an escape from the via field created by the device under test interface element 43. These vias require a controlled depth back-drill to remove conductive metal stubs that will interfere with the circuit performance. The quality of this back-drill directly influences jitter performance. This item is specific to prior art and is shown for comparison purposes.

An interposer or daughter card containing the embedded loopback circuit element 44. The interposer may use any of the three described embedded loopback methods or associated schematics. The interposer approach allows the embedded loopback to be retrofitted to a DIB that does not currently use embedded loopback (including a DIB described in FIG. 13). This allows a low cost upgrade path for existing DIB's/prior art. It also has test benefit in characterization, where an end user may also desire to connect the device to a mission mode test evaluation.

An interface mechanism of the interposer to the DIB element 45. The interface mechanism may use—but is not limited to—a solder method, a sintering paste method, an electrically conductive elastomer, or a metal spring contact probe.

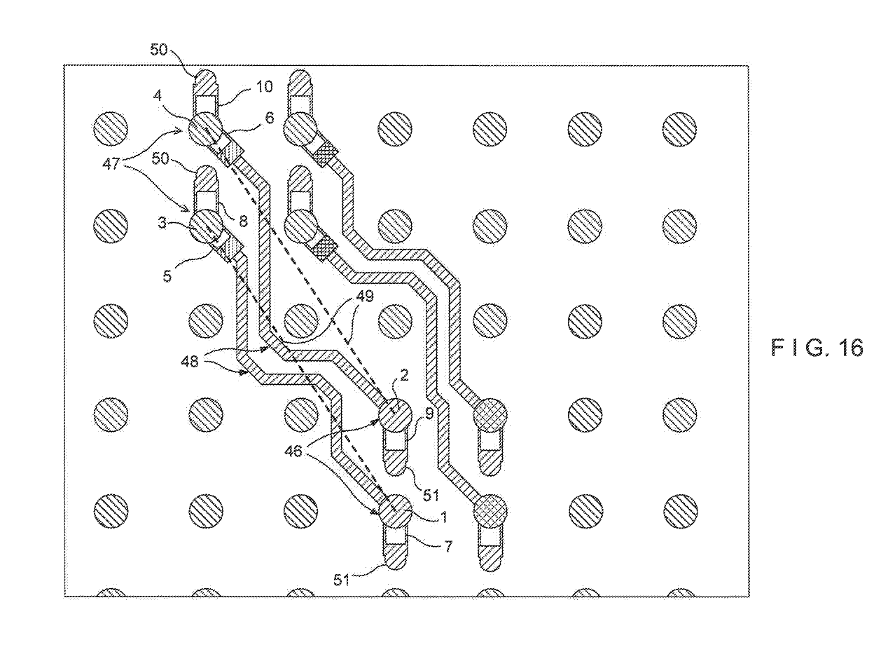

(FIG. 16) Pad and micro-via connecting the Device Under Test (DUT) Tx terminals to the Tx tap component (i.e. resistor [7], [9] in FIG. 1). The pads and vias are schematically represented in FIG. 1, nodes [1] and [2] element 46.

(FIG. 16) Pad and micro-via connecting the Device Under Test (DUT) Rx terminals to the Rx tap component (e.g. resistor [8], [10] in FIG. 1) and in this case the coupling capacitors [5] and [6] element 47. The pads and vias are schematically represented in FIG. 1, nodes [3] and [4] element 47.

(FIG. 16) The interconnect traces from the Tx micro-vias [1], [2] to the coupling capacitors [5], [6]. In this layout, the coupling capacitors are located at one end of the interconnect trace. This is not a requirement of this disclosure, and the capacitors may be located anywhere on this interconnect trace Element 48

(FIG. 16) The straight line distance between the Tx micro-vias and the Rx micro-vias element 49. This represents the theoretical shortest loopback trace length. Practical considerations—mainly other Device Under Test interconnect points and associated vias—most often prevent the straight line distance from being used. However, the requirement to route electrical connections only increased the length by a multiple of 1.41 over the straight line distance.

(FIG. 16) Micro-via connections to the tap components for Rx DC and low frequency measurements element 50. These are represented schematically by nodes [15], [16] in FIG. 1.

(FIG. 16) Micro-via connections to the tap components for Tx DC and low frequency measurements element 51. These are represented schematically by nodes [13], [14] in FIG. 1.

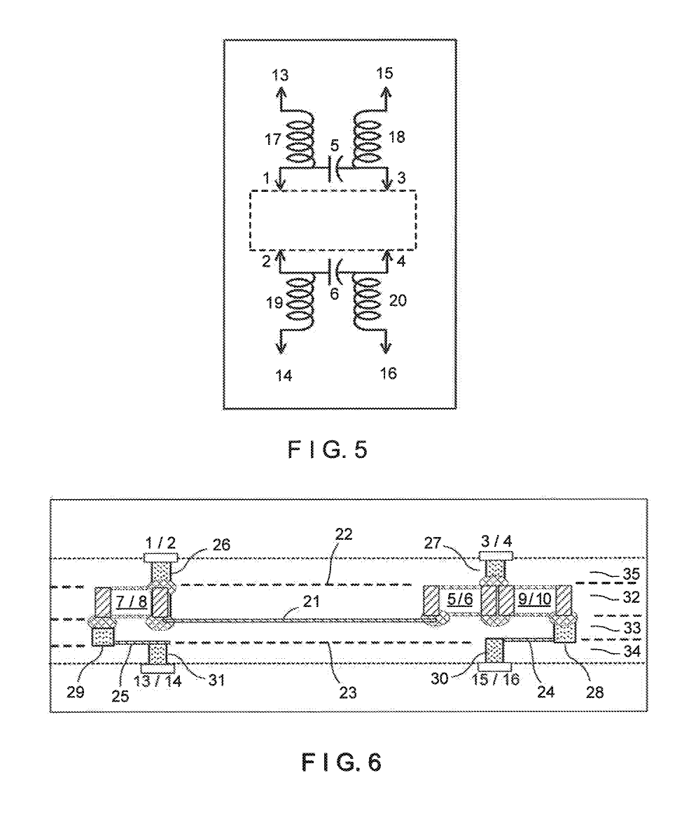

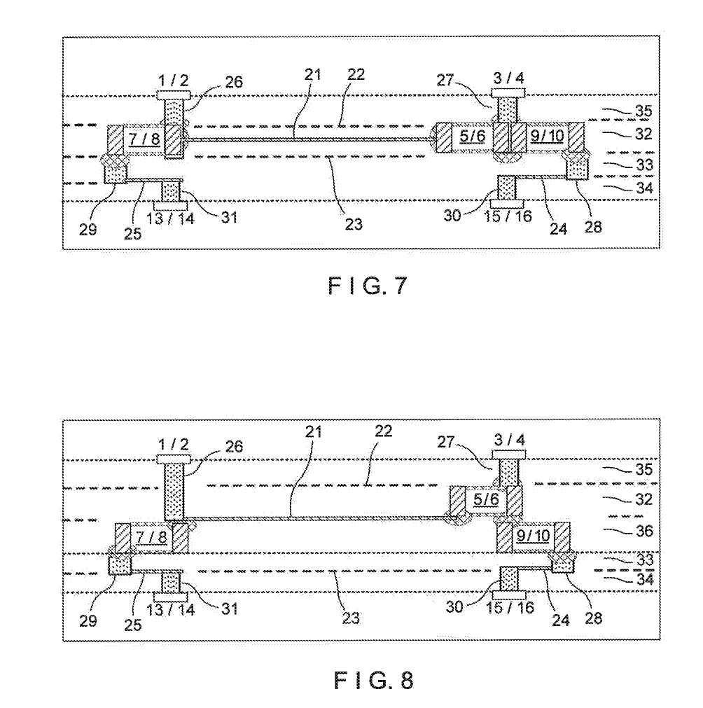

Referring now to FIGS. 6 and 7 of the drawings, the first structure places all components on a single embedded layer in the printed circuit board. This implementation is for pin grid arrays 0.65 mm and greater. The left top of the FIG. 6 shows an interface pad [1/2] for the Transmit signal from the device under test. The device under test connects to this pad through a high speed interface method, which is very important but peripheral to this disclosure. Via (micro-via) [26] connects the pad to the tap component [7/8], shown as a resistor. It may be an inductor [17/19]. Use of an inductor requires a u-shaped cap to create an air cavity. The tap component [7/8] routes to micro-via [29] and then connects to traces or circuitry through trace [25] and via [31]. This completes the tap for the transmit side.

Trace 21 is the primary loopback path and connects via [26] and the terminal of component [7/8] to the primary coupling capacitor [5/6]. The capacitor [5/6] then completes the loopback path by connecting to via [27] and the receive interface pad [3/4]. FIGS. 6 and 7 show the primary coupling capacitor located under the receive pad [3/4] and via [27]. The primary coupling capacitor may also be located under the transmit pad [1/2] and via [26] or it may be in the middle of the primary loopback trace [21].

The tap on the receive side shows the tap component [9/10] shown as a resistor connecting directly under Via (micro-via) [27]. It may be an inductor [18/20]. Use of an inductor requires a u-shaped cap to create an air cavity. The tap component [9/10] routes to micro-via [28] and then connects to traces or circuitry through trace [24] and via [30]. This completes the tap for the receive side.

The location of the tap components do not have to be located at vias [26, 27]. It is more desirable for the tap components to be placed directly next to the terminals of the primary coupling capacitor. However, this is only possible with devices having a pin grid array pitch of 1 mm or larger.

The second implementation for an embedded serial loopback structure shown in FIG. 8 uses two component layers and places the tap components on a layer below the primary loopback path. This creates a thicker embedded structure but results in a smaller X-Y footprint. FIG. 8 allows embedded loopback at fine pitch grid arrays (0.5 mm and below) due to the smaller X-Y footprint.

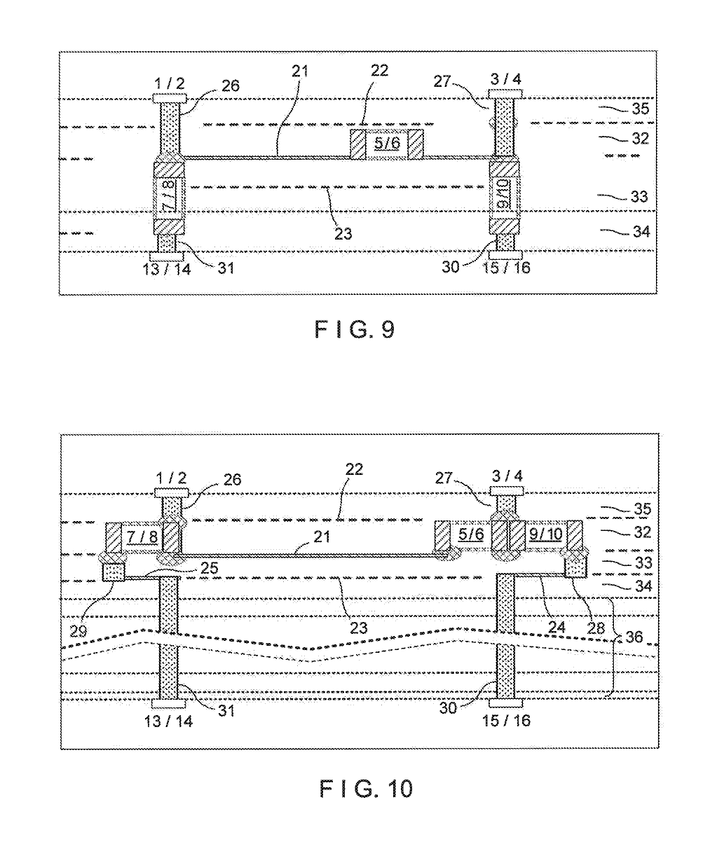

The third implementation for an embedded serial loopback structure (see FIG. 9) uses two component layers and places the tap components on a layer below the primary loopback path. In this case, the tap component (e.g. a resistor) is rotated for a vertical orientation. This creates a thicker embedded structure but results in a smaller X-Y footprint. The vertical component also reduces parasitic connections associated with the micro-vias [29/28] and connecting trace [25/24] in FIGS. 6-8. FIG. 9 also allows embedded loopback for fine pitch grid arrays (0.5 mm and below).

All the figures of the drawings show an alignment of via [31/30] and via [26/27]. This is not a requirement of the structure when the structure is fully integrated into a larger printed circuit board (FIG. 10). It is a critical part of the structure when the loopback structure is independently used as a daughter card or retrofitted to an existing printed circuit board. FIG. 6 is a first embodiment of the present invention for a an embedded loopback circuit in a cross-sectional view (1/2) wherein all components are co-planar and tap resistors [7-10] and tap inductors [17-20] may be interchanged and the tap inductors require air core cavity. (FIG. 1 is used as an example. Any of the 5 passive topologies may be used in a cross-sectional view (1/2) of the schematic. In this method all components are co-planar. Tap resistors [7-10] and tap inductors [17-20] may be interchanged (e.g. FIG. 5). Tap inductors require air core cavity. The key feature of this topology is that the electrical length depends solely on the pin assignment of the integrated circuit under test. In most cases the loopback path will be less than 4.4 mm—the criteria discussed in prior art;

FIG. 7 is a variation of the embodiment of FIG. 6 in which the components are coplanar ions for an embedded loopback circuit in a cross-sectional view (1/2). (FIG. 1 is used as an example) wherein all components are co-planar, tap resistors [7-10] and tap inductors [17-20] (e.g. FIG. 5) may be interchanged, tap inductors require air core cavity and trace 21 is shown being centered on the component terminals. Like FIG. 6, this implementation will be less than the 4.4 mm criteria;

FIG. 8 is a third embodiment providing for finer pitch wherein the embedded components use two layers to allow for fine pitch implementation in a cross-sectional view (1/2). Tap resistors [7-10] and tap inductors [17-20] may be interchanged (e.g. FIG. 5) and tap inductors require an air core cavity. The second method does not have a specific performance benefit over the first method. However, it allows implementation in a finer pitch of integrated circuit. Like the first method, the loopback electrical length depends on the integrated circuit pin assignment. In most cases, it is less than the 4.4 mm criteria for 28 GBPS.

FIG. 9 is a fourth embodiment of the present invention for an embedded loopback circuit employing multiple layers e.g. layers to allow for fine pitch implementation, tap components are oriented vertically, tap resistors [7-10] and tap inductors [17-20] may be interchanged and tap inductors require air core cavity Method 3 has a performance benefit over Method 1 and 2 by reducing the requirements for micro-vias. It allows implementation in a finer pitch of integrated circuit. Like the first method, the loopback electrical length depends on the integrated circuit pin assignment. In most cases, it is less than the 4.4 mm criteria for 28 GBPS.

FIG. 10 is a fourth embodiment of the present invention for an embedded loopback circuit providing for even finer pitch than the embodiment of FIG. 9 in a thicker printed circuit board.

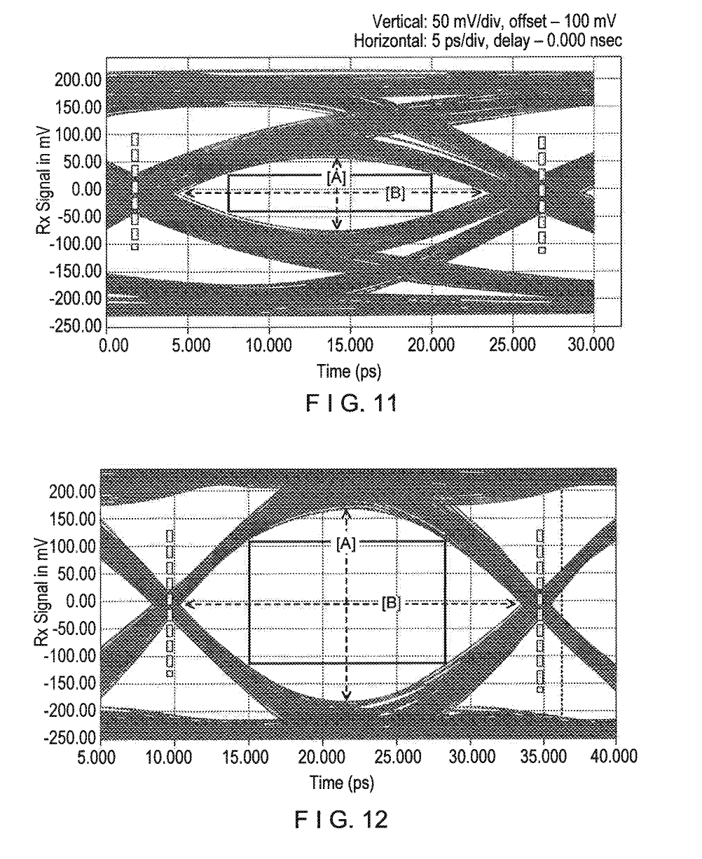

FIG. 11: This shows the data eye opening @ 40 Gbps using the best possible implementation of prior art. (The data eye is for determining the quality and degradation in a serial data link. It is an oscilloscope capture that partitions and overlays each clock period.) The maximum “eye height” [A] for the prior art implementation is 26% of the initial amplitude. The maximum “eye width” is 76% (or 0.76 UI) of the period.) FIG. 11 uses the schematic shown in FIG. 1. It also assumes a common set of non-ideal parasitic parameters associated with the integrated circuit Tx output and the Rx input.

FIG. 12: This shows the data eye opening @ 40 Gbps using the Method 1 implementation of this disclosure. The maximum “eye height” [A] for the prior art implementation is 71% of the initial amplitude. The maximum “eye width” is 91% (or 0.91 UI) of the period.) When compared to FIG. 11 the eye opening improves by a multiple factor of 2.73 and the eye width improves by multiple factors 1.2. FIG. 12 uses the schematic shown in FIG. 1. It also assumes the same common set of non-ideal parasitic parameters associated with the integrated circuit Tx output and the Rx input used in FIG. 11.

FIG. 13: This shows “prior art” method for implementing the schematics in FIGS. 1-5 for serial data loopback testing. Electrical signals originate from the Tx pins of the Device Under Test (DUT) [37] and travel to the test circuitry [42] through the DUT interface [38] (solder, socket or probe head) and left via/backdrill structure [43], a pc board trace, and left via/backdrill structure [41]. The center component in [42] represents the critical coupling capacitor, and the left and right components provide the tap element (resistor or inductor), which allows low frequency testing of the serial link. [40] represents the pc board trace connecting the tap components to the test equipment. The high speed signal returns to the Rx pin of the DUT [37] through the right via/backdrill structure [41], a pc board trace, left via/backdrill structure [43], and the DUT interface [38] (solder, socket or probe head).

FIG. 14: This shows integrated embedded loopback circuitry for implementing the schematics in FIGS. 1-5. Depending on pitch requirements, this may use one of three implementation methods, as described in FIGS. 6-9. Electrical signals originate from the Tx pins of the Device Under Test (DUT) [37] and travel to the test circuitry directly under the DUT through the DUT interface [38] (solder, socket or probe head) and left micro-via. A very short pc board trace exists in the test circuitry that connects the Tx signal path to the left terminal of the coupling capacitor. The right terminal of the coupling capacitor connects to a second micro-via, which returns the signal to the Rx pin of the DUT, through the electrical interface [38]. [40] represents the pc board trace connecting the tap components to the test equipment. The tap component terminals use a micro-via connecting to a regular (yet blind) via to connect to the low frequency test equipment interface. In the high frequency path there are only 4 micro-vias of extremely short length—vs. the 8 via/back drill structures used in prior art. When the loopback short trace can be a direct straight-line connection between Tx and Rx pins, it is the shortest possible connection between the two DUT pins. While this is usually not possible, the short connection is often very close to the theoretical straight line distance.

FIG. 15: This shows a detachable embedded loopback circuitry for implementing the schematics in FIGS. 1-5. Depending on pitch requirements, this may use one of three implementation methods, as described in FIGS. 6-9. The detachable method offers the benefit of retrofitting embedded loopback circuitry. Electrical signals originate from the Tx pins of the Device Under Test (DUT) [37] and travel to the test circuitry directly under the DUT through the DUT interface [38] (solder, socket or probe head) and left micro-via. A very short pc board trace exists in the test circuitry that connects the Tx signal path to the left terminal of the coupling capacitor. The right terminal of the coupling capacitor connects to a second micro-via, which returns the signal to the Rx pin of the DUT, through the electrical interface [38]. All of this resides in a detachable printed circuit board [44], commonly referred to as an “interpose”, “daughter card”, or “personality board”. [45] represents the electrical interface between the interposer and the device interface board (DIB). [40] represents the pc board trace connecting the tap components to the test equipment. The tap component terminals use a micro-via connecting to a blind-via and then routing out of the interposer [44] through the interface [45] and into a regular via in the DIB [39] for the low frequency test equipment connection [40]. The high speed benefits—i.e. reduction of via structures and printed circuit board trace length—are the same in FIG. 15 as they are in 14.

FIG. 16: This shows a top view of the embedded component loopback circuit using the schematic in FIG. 1 and the Method (1) for large pitches in FIGS. 6 and 7. It shows two embedded loopback circuits in their entirety. Only the left circuit is label, allowing more visual clarity on the right circuit. (This layout is taken from an actual implementation.) The Tx differential signal propagates from the Device Under Test (DUT) to the micro-vias [46] (Micro-via 26 in FIGS. 6/7). The signal travels through the high speed trace [48] to the coupling capacitors [5], [6]. The signal then returns to the DUT, after AC coupling, through the micro-vias [47], which correspond to schematic nodes [4], [6] in FIG. 1 (Micro-via 26 in FIGS. 6/7). The Tx tap components [7], [9] connect to the DC/low frequency test equipment through the micro-vias [51] (Micro-via [29] in FIGS. 6/7) and schematic nodes [13], [14] in FIG. 1. The Rx tap components [8], [10] connect to the DC/low frequency test equipment through the micro-vias [50] (Micro-via [28] in FIGS. 6/7) and schematic nodes [15], [16] in FIG. 1. The remainder of the escape structures for Tx and Rx low frequency test and connecting to the test equipment are physically beneath this structure. Dashed line [49] shows the straight line distance between the Tx and Rx ports. It represents the theoretical shortest distance limit between Tx and Rx for a given integrated circuit device. The unconnected, unlabeled pads on grid represent other signals requiring vias. They interfere with the straight line path and require the physical high speed path to route around them. This increases the signal path distance, to a new maximum limit of 1.4121 (square root of 2) multiplied by the straight line distance.

While certain embodiments have been shown and described, it is distinctly understood that the invention is not limited thereto but may be otherwise embodied within the scope of the appended claims.

What is claimed:

1. A structure for placing components directly beneath a surface of a printed circuit board interfacing to a device under test comprising:
micro-vias and traces connecting components including transmitter components (TX) and receiver components (RX) are formed into a loopback circuit for connection to a device under test (DUT) said connecting being accomplished by a coupling capacitor with a shortest possible electrical length approximating a straight line between said components and said distance is a length of said short straight line times a square root of 2 so that said receiver components are beneath the DUT.

2. The structures according to claim 1 wherein the receiver has tap components that are beneath and connected to the DUT through the micro-vias and schematic nodes and a remainder of escape structures for Tx and Rx low frequency test and connecting to the DUT are physically beneath the structure with said straight line distance between the Tx and Rx ports, said straight line distance representing a shortest distance limit between Tx and Rx for a given integrated circuit device increasing a signal path distance, to a new maximum limit of 1.4121 (square root of 2) multiplied by said straight line distance.

3. The structure according to claim 1 whereby passive commercially available components are placed within the interior of a printed circuit board (embedded) in such a way as to form a high performance loopback path for purposes of testing serial data paths within an integrated circuit.

4. The structure according to claim 1 where by all loopback components are co-planar.

5. The structure according to claim 1 where by all loopback components use multiple planar layers.

6. The structure according to claim 1 where by loopback components use both horizontal and vertical orientations for loopback components.

7. The structure according to claim 1 that uses resistive or inductive tap components with capacitive coupling for the primary loopback path.

8. The structure according to claim 1 that uses a hybrid pi attenuation filter with capacitive coupling for the primary loopback path.

9. The structure according to claim 1 that only uses capacitive coupling for the primary loopback path.

10. The structure according to claim 1 that uses an air-core cavity for all inductors.

11. The structure according to claim 1 that uses two terminal, surface mount resistors, inductors, or capacitors of any size, tolerance or temperature coefficient.

12. The structure according to claim 1 that provides the shortest possible external loopback path with capacitive coupling.

13. The structure according to claim 1 that may be a stand-alone printed circuit board/interposer/daughter card.

14. The structure according to claim 1 that may be fully integrated into a much thicker and larger printed circuit board.

15. The structure according to claim 1 and claim 11 that may be retrofitted to an existing printed circuit board using any interconnect technology.

16. The structure according to claim 1 that does not occupy X-Y on the printed circuit board by placing all circuitry under the device under test.

17. A method for placing components directly beneath a surface of a printed circuit board interfacing to a device under test, the steps comprising:
using micro-vias and traces with components including transmitter components (TX) and receiver components (RX) formed into a loopback circuit for connecting to a device under test (DUT);
said connecting step being accomplished by a coupling capacitor with a shortest possible electrical length approximating a straight line between said components and said DUT and said distance is a length of said short straight line times a square root of 2 so that said receiver components are beneath the DUT.

18. The method according to claim 17 wherein a single layer embedding is provided for large pitch.

19. The method according to claim 18 wherein said pitch is 0.65 mm or larger.

20. The method according to claim 17 wherein multiple layers of embedding is provided for fine pitch.

21. The method according to claim 19 wherein said pitch is either 0.5 mm or 0.4 mm.

22. The method according to claim 17 wherein a multi-axis, vertical and horizontal, embedding is provided for the finest pitch

23. The method according to claim 22 wherein said pitch is 0.4 mm, 0.35 mm and 0.3 mm for higher performance.
